(19) United States
(12) Patent Application Publication
(10) Pub. No.: US 2025/0321822 A1
(43) Pub. Date: Oct. 16, 2025

(54) IN-FIELD SAFETY MECHANISM FOR MEMORY DEVICES

(71) Applicant: Micron Technology, Inc., Boise, ID (US)

(72) Inventors: Melissa I. Uribe, El Dorado Hills, CA (US); John Maroney, Irvine, CA (US)

(21) Appl. No.: 19/174,397

(22) Filed: Apr. 9, 2025

Related U.S. Application Data
(60) Provisional application No. 63/632,830, filed on Apr. 11, 2024.

(51) Int. Cl. G06F 11/07; B60W 50/00; B60W 50/02; B60W 60/00

(52) U.S. Cl. CPC G06F 11/079; B60W 50/0225; B60W 60/0015; G06F 11/073; G06F 11/0769; B60W 2050/0083

(57) ABSTRACT

A memory device may comprise a memory controller configured for controlling access to an array of memory cells. The memory controller may be configured to perform one or more memory device functions that enable the host to perform system operations. The memory controller may include at least one safety mechanism and at least one safety mechanism monitor. The safety mechanism(s) may determine memory device fault condition(s) that has a potential to adversely affect performance of at least one of the one or more memory device functions. The safety mechanism monitor(s) may determine at least one safety mechanism fault condition that has a potential to adversely affect an ability of the safety mechanism(s) to determine the memory device fault condition(s). The host may assess whether the safety mechanism(s) is reliable based on the safety mechanism fault condition(s).

### PRIORITY APPLICATION

This application claims the benefit of priority to U.S. Provisional Application Ser. No. 63/632,830, filed Apr. 11, 2024, which is incorporated herein by reference in its entirety.

### BACKGROUND

Memory devices are typically provided as internal, semiconductor, integrated circuits in computers or other electronic devices. There are many different types of memory, including volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, such as phase-change random-access memory (PCRAM), resistive random-access memory (RRAM), magneto resistive random-access memory (MRAM), or storage class (e.g., memristor) memory, among others.

Memory devices are being incorporated into many systems and are being relied upon to reliably perform operations within these systems. For example, industrial systems may have various standards that must be maintained to manage risk and ensure that processes are accurately adhered to in order to consistently manufacture a desired product in a safe environment. Automobile systems, which may include assisted driving or autonomous driving, are another example of systems with standards, such as Automotive Safety Integrity Level (ASIL), that classifies risks and sets safety requirements.

Some of these standards relate to the concept of functional safety, which aims to eliminate uncertainty caused by failure of electronic systems during operation. Whereas quality attempts to reduce failures, functional safety attempts to avoid risk by detecting faults and informing the host that there is something wrong. This allows the host to elegantly shut themselves down or otherwise avoid using bad data. For an automotive safety system, this may involve giving control back to the driver or pulling the car over to the side of the road.

Since detectors, or safety mechanisms, are relied upon for the functional safety risk avoidance, there is a need for in-field monitoring of the safety mechanism operation for conformance to standards.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates an example of a block diagram of a system that includes a host and that further includes a memory device with safety mechanisms that are designed to detect and alert the host of memory device faults.

FIG. 2 is a block diagram of an autonomous vehicle system with examples of some components and/or subsystems.

FIG. 3 illustrates an example block diagram of a memory device including a memory controller and a memory array having a plurality of memory cells.

FIG. 4 illustrates, by way of example and not limitation, a memory device with safety mechanism(s).

FIG. 5 illustrates, by way of example and not limitation, a system that includes a host and a memory device that includes safety mechanism monitor(s).

FIG. 6 illustrates, by way of example and not limitation, a method performed using a host and a memory device that includes an array of memory cells and a memory controller configured for controlling access to the array of memory cells.

FIG. 7 illustrates, by way of example and not limitation, a diagram of a UFS system.

FIG. 8 illustrates an example of an environment including a host device and a managed memory device configured to communicate with each other over a communication interface.

### DETAILED DESCRIPTION

Some electronic devices can be broken down into several main components: a processor (e.g., a central processing unit (CPU) or other main processor); a graphics processing unit (GPU); memory (e.g., random access memory (RAM), such as dynamic RAM (DRAM), mobile or low-power DDR RAM, etc.); a storage device (e.g., non-volatile memory (NVM) device, such as flash memory, read-only memory (ROM), a solid state drive (SSD), or other memory device, etc.); and a user-interface (e.g., a display, touch-screen, keyboard, one or more buttons, etc.). Different electronic devices have different storage needs.

Flash memory is used as non-volatile memory for a wide range of electronic applications. Two common types of flash memory array architectures include NAND and NOR architectures, named after the logic form in which the basic memory cell configuration of each is arranged. The memory cells of the memory array are typically arranged in a matrix. In an example, the gates of each floating gate memory cell in a row of the array are coupled to an access line (e.g., a word line). In a NOR architecture, the drains of each memory cell in a column of the array are coupled to a data line (e.g., a bit line). In a NAND architecture, the drains of each memory cell in a string of the array are coupled together in series, source to drain, between a source line and a bit line. Word lines coupled to the gates of the unselected memory cells of each group are driven at a specified pass voltage (e.g., Vpass) to operate the unselected memory cells of each group as pass transistors (e.g., to pass current in a manner that is unrestricted by their stored data values). The memory arrays may be two-dimensional (2D) structures or may be three-dimensional (3D) structures.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. However, flash memory cells can also represent one of more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell that can store more than one bit of data per cell (i.e., that can represent more than two programmed states).

Memory arrays or devices can be combined together to form a storage volume of a memory system, such as a solid state drive (SSD), a Universal Flash Storage (UFS) device, multimedia card (MMC) solid-state storage devices, and embedded MMC (eMMC) devices. MMC devices include a number of parallel interfaces (e.g., an 8-bit parallel interface) with a host device and are often removable and separate components from the host device. In contrast, eMMC devices are attached to a circuit board and considered a component of the host device, with read speeds that rival serial ATA (SATA) based SSD devices. UFS is a standard interface designed for low-power applications including automotive applications. UFS devices, including controllers and firmware, communicate with a host device using a low-voltage differential signaling (LVDS) serial interface with dedicated read/write paths, further advancing greater read/write speeds. These devices have advantages over traditional hard drives with moving parts with respect to, for example, performance, size, weight, ruggedness, operating temperature range, and power consumption. For example, these devices can have reduced seek time, latency, or other electromechanical delay associated with magnetic disk drives. These devices may also use non-volatile flash memory cells to obviate internal battery supply requirements, thus allowing the drive to be more versatile and compact. These solid state devices can include a number of memory devices, including a number of dies or logical units (LUNs). Each die can include a number of memory arrays and peripheral circuitry thereon, and the memory arrays can include a number of blocks of memory cells organized into a number of physical pages. The solid state devices can receive commands from a host in association with memory operations, such as read or write operations to transfer data (e.g., user data and associated integrity data, such as error data and address data, etc.) between the memory devices and the host, or erase operations to erase data from the memory devices.

Memory devices are being incorporated into many systems, such as but not limited to industrial and automotive systems and are being relied upon to reliably perform operations within the systems. For example, an automotive system, which may include assisted driving or autonomous driving, may have standards such as Automotive Safety Integrity Level (ASIL) that classifies risks and sets functional safety requirements accordingly. The ISO 26262 standard for the functional safety of road vehicles defines ASIL as a risk classification system, which establishes safety requirements based on the probability and acceptability of harm caused by malfunctioning electrical or electronic systems. Automobile systems may include, but are not limited to, systems such as airbags, braking, power steering, cruise control, lane keeping assist, self-parking, wipers, headlights, brake lights, and taillights. Factors for classifying risk include the severity of the risk of failure, how often the failure may occur, and how much the driver can safely respond to the failure. For example, ASIL identifies four levels (A, B, C, D) of increasing degrees of hazard, where D represents the highest degree of automotive hazard. An automotive system like power steering may have higher risks associated with failure and be classified as ASIL-D whereas some automobile lighting systems may have a lesser risk associated with failure and be classified as ASIL-A or ASIL-B.

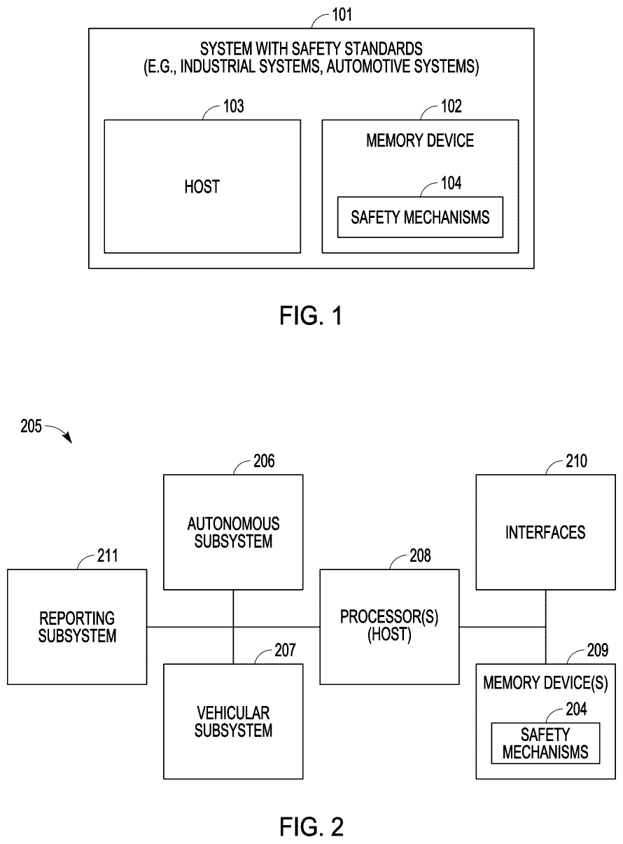

FIG. 1 illustrates an example of a block diagram of a system 101 that includes a memory device 102 and a host 103, wherein the memory device 102 has safety mechanisms 104 that are designed to detect and alert the host 102 of memory device faults. The host 103 may also have safety mechanisms to detect faults in the memory or itself. A properly operating memory device 103 performs memory device function(s) (e.g., various functions that enable proper writing and reading of data) that enable the host 102 to perform system operations as designed. In an industrial system, by way of example and not limitation, the system operations may relate to operations that ensure that processes are accurately adhered to in order to consistently manufacture a desired product in a safe environment. In automobile systems, by way of example and not limitation, the system operations may relate to operations used to provide assisted driving or autonomous driving. However, a memory device fault may result in no response or erroneous data to the host. The erroneous data may be corrupt data, wrong data such as data read from the wrong address or lost or old data such as data that failed to be written into the memory or was written into the wrong location in memory. An undetected memory device fault may cause the host to improperly perform a system operation as the host may be relying on incorrect information from the memory device when performing the system operation. Thus, hosts may rely on safety mechanisms, which may include hardware and/or firmware, to tell them something is wrong so that they do not use bad data.

The present inventors recognized that, among other things, safety mechanisms are not immune to faults and that a faulty safety mechanism can affect the ability of the safety mechanisms to detect and alert the host of the failure. By way of example and not limitation, a single ionizing particle (e.g., “a neutron event” or “single event error”) may cause a soft error by changing a bit, which may adversely affect a safety mechanism. Therefore, it is desirable to provide a means for confirming the functionality of safety mechanisms in memory devices to further improve the ability of a memory device to alert the host when there is a failure risk in the memory device.

Memory device(s) may be used for various functions within an automotive system, which may include assisted driving or autonomous driving. For example, these memory device(s) may store various types of data such as user data, sensor data, configuration data and navigational maps. User data may include authorization data that may allow the user to open a door or start an engine and may include data for user-specific presets such as seat position, mirrors, phone communication, and the like. The sensor data may include data from sensors mounted in the vehicle or sensors worn by drivers or passengers. Configuration data may include data associated with the operation of the vehicle.

FIG. 2 is a block diagram of an autonomous vehicle system with examples of some components and/or subsystems. The autonomous subsystem, 206, vehicular subsystem, and host 208 may also have safety mechanisms which may be used to detect faults in the memory or itself. The system 205 may include an autonomous subsystem 206 which may include, by way of example and not limitation, map data radar lidar, sonar, cameras, GPS receivers, and the like that may be used to provide location awareness, collision avoidance, and other standard autonomous vehicle functionality. A vehicular subsystem 207 may include systems such as anti-lock braking, engine control units, transmission control units, and the like that may be used to control the operation of the autonomous vehicle in response to data from the autonomous vehicle subsystem. Processor(s) 208, which include host(s) for memory device(s), may comprise central processing units, FPGAs, or any range of processing devices needed to support the operations of the autonomous vehicle. The memory device(s) 209 may include DRAM or other suitable volatile RAM for temporary storage of data used by the processors and long-term storage such as solid-state drives (SSDs), Universal Flash Storage (UFS), or Embedded Multi-Media Card (eMMC) storage. The long-term storage may store, by way of example and not limitation, high-definition maps, routing data, and any other data requiring permanent or semi-permanent storage. The memory device(s) 209 may include safety device(s) 204 configured to detect memory device faults and provide alerts to the host (e.g., processor(s)) of the memory device faults. By way of example, UFS and SSD are being designed for use in automotive ASIL systems (like assisted driving and autonomous driving), including incorporating safety mechanisms in the UFS/SSD to avoid automotive application system failures by detecting and alerting the host of faults in the UFS/SSD like corrupt data, wrong data (read from wrong address) to the host system, lost/old data (no write, write to wrong location, etc.), and no response. The interfaces 210 may comprise various display units positioned within the autonomous vehicle (e.g., an in-dash screen), and the reporting subsystem 211 may collect, process and transmit data.

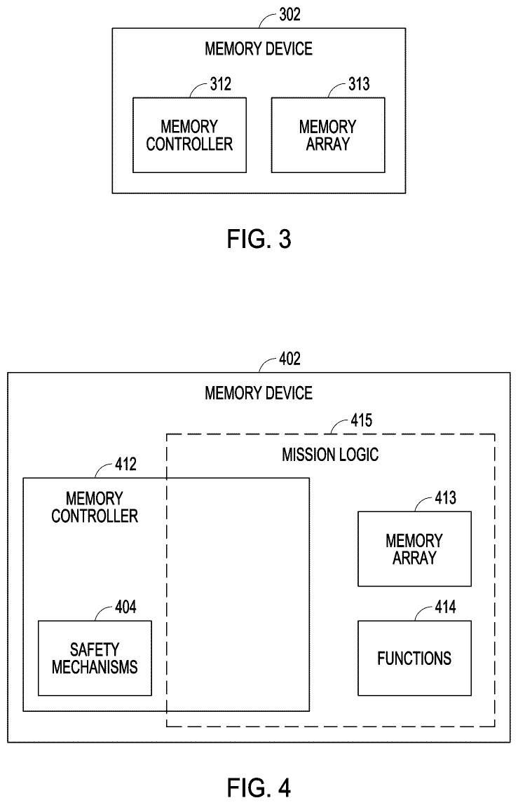

FIG. 3 illustrates an example block diagram of a memory device 302 including a memory controller 312 and a memory array 313 having a plurality of memory cells. One or more physical interfaces can be used to transfer data between the memory device 302 and a host, such as host 103 in FIG. 1 or host 208 in FIG. 2. By way of example and not limitation, the physical interface(s) may include a serial advanced technology attachment (SATA) interface, a peripheral component interconnect express (PCIe) interface, a universal serial bus (USB) interface, M-PHY for UFS, 8-bit parallel, eMMC, or one or more other physical connectors or interfaces.

The memory controller 312 may receive instructions from the host, and may communicate with the memory array 313, such as to transfer data to (e.g., write or erase) or from (e.g., read) one or more of the memory cells of the memory array. The memory controller 312 can include, among other things, hardware or firmware. For example, the memory controller 312 can include one or more memory control units, circuits, or components configured to control access across the memory array 313 and to provide a translation layer between the host and the memory device. The memory controller can include one or more input/output (I/O) circuits, lines, or interfaces to transfer data to or from the memory array.

The memory controller 312 may include a memory management component and a memory controller component. The memory management component may include, among other things, circuitry or firmware, such as a number of components or integrated circuits associated with various memory management functions, including wear leveling (e.g., garbage collection or reclamation), error detection or correction, block retirement, or one or more other memory management functions. The memory management component may parse or format host commands (e.g., commands received from a host) into device commands (e.g., commands associated with operation of a memory array, etc.), or generate device commands (e.g., to accomplish various memory management functions) for the memory controller component or one or more other components of a memory device. These memory management components allow the memory device 302 to properly write and read data. Some safety mechanism(s) may be incorporated to monitor for failures in these components.

The memory management component may include management tables configured to maintain various information associated with one or more component of the memory device (e.g., various information associated with a memory array, or one or more memory cells coupled to the memory controller). For example, the management tables may include information regarding block age, block erase count, error history, or one or more error counts (e.g., a write operation error count, a read bit error count, a read operation error count, an erase error count, etc.) for one or more blocks of memory cells coupled to the memory controller. In certain examples, if the number of detected errors for one or more of the error counts is above a threshold, the bit error can be referred to as an uncorrectable bit error. The management tables can maintain a count of correctable or uncorrectable bit errors, among other things. The memory management component can include a redundant array of independent disks (RAID) unit (the term “disks” is a carryover from prior implementations using had disk drives and does not require that the RAID unit include a physical disk). The RAID unit can provide data reliability through, among other things, redundant memory operations and redundant memory storage. The memory management component may include UFS messaging. Messages transfer information between a UFS host and device. The messages may include UFS Protocol Information Units (UPIU), which are defined data structures that contain a number of sequentially addressed bytes arranged as various information fields. There are different types of UPIU. All UPIU structures contain a common header area at the beginning of the data structure (lowest address). The remaining fields of the structure vary according to the type of UPIU. The memory management component may include performance throttling, which provides device side control of the data transfer speed. Storage devices (such as NAND devices) may have one or more indicators that trigger performance throttling to prevent damage to the storage device, prevent errors when reading values from the storage device, and the like. For example, high temperatures (either ambient temperatures or device temperatures) can impact the reliability of the storage device and may cause increased power consumption due to increased transistor leakage at high temperatures. By way of example and not limitation, a safety mechanism may be used to detect and alert the host when there is an uncorrectable bit error, or a number of errors above a threshold, or corrupt management tables.

The memory controller component may include, among other things, circuitry or components configured to control memory operations associated with writing data to, reading data from, or erasing one or more memory cells of a memory device coupled to the memory controller. The memory operations can be based on, for example, host commands received from a host, or internally generated by the memory management component or the memory controller component (e.g., in association with wear leveling, error detection or correction, etc.). The memory controller component may include an error correction code (ECC) component, which can include, among other things, an ECC engine or other circuitry configured to detect or correct errors associated with writing data to or reading data from one or more memory cells of a memory device coupled to the memory controller. The memory controller may be configured to actively detect and recover from error occurrences (e.g., bit errors, operation errors, etc.) associated with various operations or storage of data, while maintaining integrity of the data transferred between a host and a memory device, or maintaining integrity of stored data (e.g., using redundant RAID storage in the RAID unit, etc.), and can remove (e.g., retire) failing memory resources (e.g., memory cells, memory arrays, pages, blocks, etc.) to prevent future errors.

FIG. 4 illustrates, by way of example and not limitation, a memory device with safety mechanism(s). The memory device 402 may include a memory controller 412, a memory array 413 and circuitry/components for performing various functions 414. A portion of the memory controller 412, the memory array 413 and the functions 414 may form part of the mission logic 415 for the memory device 402. The mission logic 415 refers to components and function that are used to access the memory to read or write the data for the host. A portion of the memory controller 312 also may include safety mechanisms 404, which may be configured to monitor for faults in the mission logic 415. Mission logic may also involve security, as memory devices are also designed to avoid attacks such as side channel attacks. If the memory device is able to correct data as part of its normal operation, such corrections are typically not reported by the safety mechanisms to the host as the memory device is operating as designed and the data remains available. However, if the safety mechanisms detect that data is corrupted or has a significant possibility of being corrupted, then the safety mechanisms inform the host that the data is corrupted and should not be relied upon. Many safety mechanisms are hardware. A nonlimiting example of a hardware safety mechanism is a voltage detector. However, safety mechanisms may also include firmware. Alerts, for example, may include hardware alerts and/or firmware alerts.

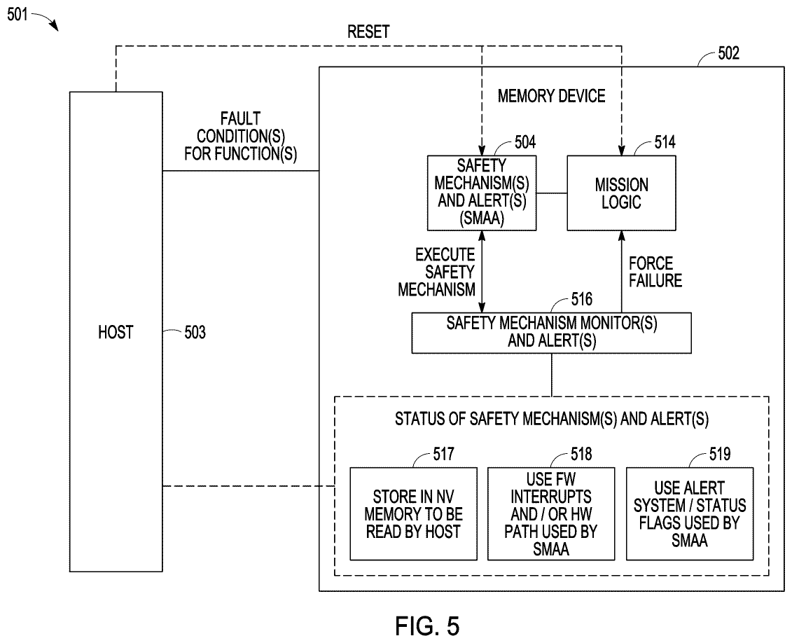

FIG. 5 illustrates, by way of example and not limitation, a system 501 that includes a host 503 and a memory device 502 that includes safety mechanism monitor(s) and alert(s) 516. The memory device 502 includes mission logic 514 and safety mechanism(s) and alert(s) (SMAA) 504. The SMAA may be part of the memory controller. Under normal operations, the safety mechanism(s) 504 detect memory device faults (e.g., faults in performing memory device functions) and alerts the host 503 of the detected memory device fault. The memory device 502 further includes safety mechanism monitor(s) and alert(s) 516, which may be part of the memory controller.

The safety mechanism monitor(s) and alert(s) 516 may be configured to force a failure in performing at least one of the one or more memory device functions and configured to determine at least one safety mechanism fault condition based on whether the at least one safety mechanism 504 detected the forced failure. The memory controller may be configured to reset the at least one memory device fault condition in response to a reset signal received from the host 503 after the failure is forced.

The at least one safety mechanism fault condition may be intermittently determined (e.g., periodically such as once per day or once per week). In some embodiments, the safety mechanism fault condition(s) is determined during times when the system is neither booting up nor performing normal system operations that are enabled by the one or more memory device functions. Rather, in an automotive example, the safety mechanism fault condition(s) may be determined upon a key off event when the automobile system is shutting down. The timing for determining the safety mechanism fault condition may be based on the assessed risk level of failure for the safety mechanism.

By way of example and not limitation, the forced failure may involve injecting one or more bits of failure into code. For example, the system may check that one bit of error was accurately corrected and may check to see if an alert was appropriately triggered when two bits of error are injected which may not be able to be corrected with confidence. In other examples, the system may change the voltage and check to see if the safety mechanism(s) correctly detect and alert of the voltage discrepancy. There are multiple safety mechanisms that are checking various conditions. The safety mechanism monitors may be designed to intermittently check the functionality of some safety mechanisms more often than other safety mechanisms. The check of various safety mechanisms may be staggered so that some are checked during one key off event in an automotive system, and other safety mechanisms are checked during another key off event. The frequency of the checks may be based on the assessed risks associated with system mechanism failure. Also, the system may be designed to provide a scheduled order of injected faults to provide an order of safety mechanism checks. Some combinations of faults may be able to be checked without intervening resets, whereas other combinations are not. Vendor specific commands may be created to test different groups of safety mechanisms.

The safety mechanism monitor(s) and alert(s) 516 may be configured to store the at least one safety mechanism fault condition in nonvolatile memory for access by the host to assess whether the at least one safety mechanism is reliable 517. The safety mechanism may be configured to react to the at least one memory device fault condition using a reaction path that includes at least one of firmware interrupts or a hardware path, and the at least one safety mechanism monitor may be configured to use the reaction path to demonstrate coverage for the reaction path 518. The safety mechanism may use an alert system and status flags to react to the at least one memory device fault condition, and the safety mechanism monitor may use the alert system and the status flags to demonstrate coverage 519. The safety mechanism monitor may be configured to work with different protocols for specific types of memory devices. SSD uses Completion Queue and UFS uses Response UPIU (UFS Protocol Information Unit). System in-the-field functionality may be confirmed during down time (like “key off”) intermittently (or scheduled periodically) (every drive cycle, once a day, or other time intervals). The forced failures may be performed one at a time with resets therebetween to ensure that a safety mechanism function is not affected by the earlier mission logic failure states. However, some safety mechanism functions may be evaluated together or sequentially without a reset therebetween. Host-initiated vendor-specific commands may be implemented via SMBus/NVMe-MI. SMBus refers to a system management bus. NVMe-MI refers to a specification for managing NVMe (nonvolatile memory express) storage devices.

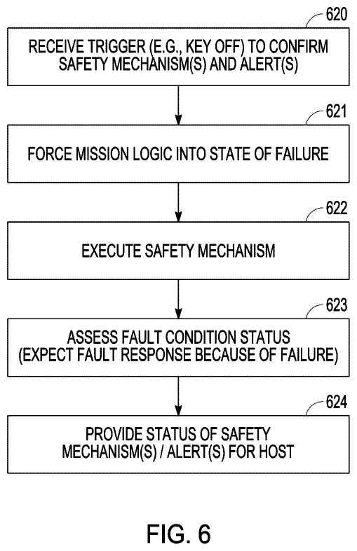

FIG. 6 illustrates, by way of example and not limitation, a method performed using a host (e.g., FIG. 5, 503) and a memory device (e.g., FIG. 4, 402; FIG. 5, 502) that includes an array of memory cells and a memory controller (e.g., FIG. 4, 412) configured for controlling access to the array of memory cells. The method provides a firmware and hardware solution that confirms the functionality of safety mechanisms in the field. The illustrated method includes receiving a trigger for performing the check of the safety mechanism(s) 620. This check may involve confirming the operability of the safety mechanism(s) and alert(s) (e.g., FIG. 4, 404; FIG. 5, 504). The trigger may be at least partially based on a timer to intermittently check the safety mechanism(s). For example, the safety mechanism(s) may be checked periodically (e.g., daily, every N number of days, weekly, and the like). The interval for checking some safety mechanism(s) may be different than the interval for checking other safety mechanism(s). The interval may be chosen by the risk classification, where safety mechanisms associated with higher risk systems are checked more often than safety mechanisms associated with lower risk systems. Thus, for example, safety mechanism(s) associated with ASIL-D systems may be checked more often than safety mechanism(s) associated with ASIL-A, ASIL-B or ASILC. Additionally, or alternatively, because the checking involves forcing faults in memory device operations, the trigger for checking the safety mechanism(s) may be based on other system conditions so as not to adversely interfere with performing normal memory device function(s) that enable a host to perform system operations or adversely interfere with determining memory device fault condition(s), using safety mechanism(s). For example, the trigger for checking the safety mechanism may be during key off events (e.g., the automotive system has or is shutting down). The time intervals between checks may be intermittent (not necessarily predefined and/or equal time periods) or may be at scheduled times.

Upon receiving the trigger, the method may proceed to forcing the memory device(s) mission logic (e.g., FIG. 4, 415, FIG. 5, 514) into a state of failure 621 and executing safety mechanism(s) 622 to determine whether the safety mechanism(s) are able to detect the failure. The safety mechanism fault condition(s) has a potential to adversely affect an ability of the at least one safety mechanism to determine the at least one memory device fault condition. At 623, the method may include assessing the fault condition status to determine if the expected fault response due to the failure occurs. At 624, the status of the safety mechanism(s) and alert(s) (e.g., FIG. 4, 404; FIG. 5, 504) may be provided for the host (e.g., FIG. 5, 503). The host may assess whether the at least one safety mechanism is reliable based on the at least one safety mechanism fault condition and may assess whether the memory controller is reliable to perform the one or more memory device functions that enable the host to perform the system operations.

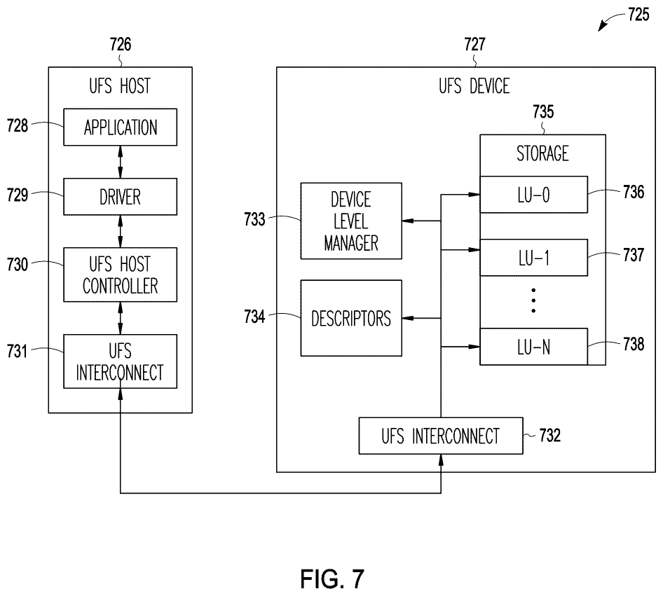

FIG. 7 illustrates, by way of example and not limitation, a diagram of a UFS system. UFS systems may be implemented in an automotive system, for example. The illustrated UFS system 725 may include a UFS host 726 and a UFS device 727. The UFS host 726 may include an application 728 that wishes to read or write data to the UFS device. The application 728 on the UFS host may use a UFS driver 729, which manages the UFS host controller 730 through a UFS Host Controller Interface 731 using a set of registers. The UFS host controller 730 may use the UFS interconnect to communicate with the UFS interconnect 732 of the UFS device 727. The UFS interconnect 732 comprises the physical layer and provides basic transfer capabilities. The physical layer may be a differential, dual simplex PHY that includes TX and RX pairs. A PHY refers to the circuitry used to implement physical layer function and connects a link layer device (often called MAC as an acronym for medium access control) to a physical medium. The UFS interconnect communicates with the components of the UFS device. UFS device 727 includes a device level manager 733 that provides device level features such as power management, and the like. Descriptors 734 store configuration related information. Storage 735 may be segmented into a plurality of Logical Unit (LU) s 0-N (736, 737, 738) which handle read/write and other storage related commands. For example, a 16 GB UFS device might be configured as 4 LUs of 4 GB each. While the disclosure herein may be described with respect to UFS, one of ordinary skill in the art with the benefit of the present disclosure will recognize that the disclosed improvements may also be applied to eMMC and other interfaces between a storage device and a host.

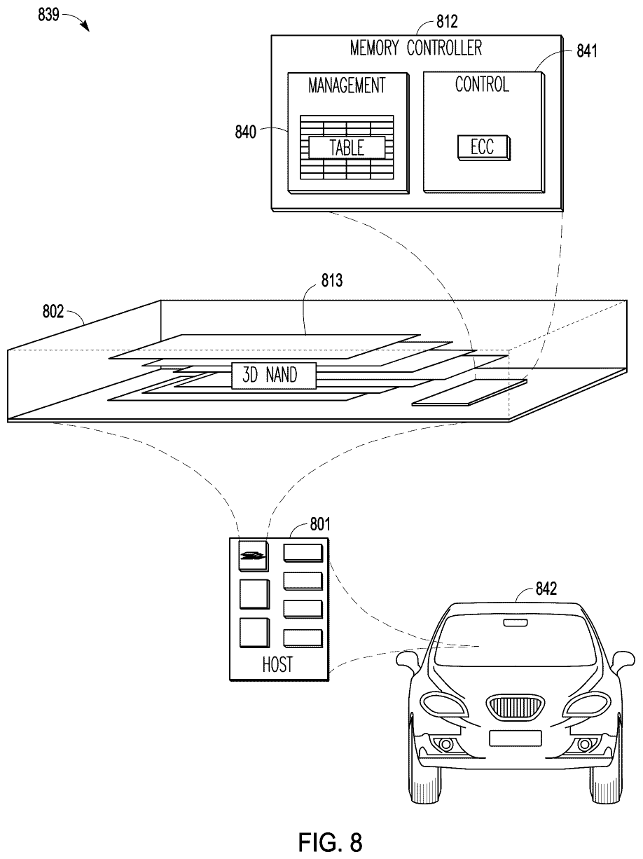

FIG. 8 illustrates an example of an environment 839 including a host device and a managed memory device configured to communicate with each other over a communication interface. Thus, as described herein, actions ascribed to the host device 801 are external to those of the managed memory device 802, even when, as illustrated, the managed memory device is a package within the host device. Thus, in some examples, the managed memory device may be included as part of the host, or the managed memory device may be a separate component external to the host device. The host device 801 or the managed memory device 802 can be included in a variety of products, such as by way of example and not limitation, an automobile or Internet of Things (IoT) devices (e.g., sensor, motor or actuator, drone, etc.) to support processing, communications, or control of industrial processes.

The illustrated managed memory device 802 includes a memory controller 812 and a memory array 813 including, for example, a number of individual memory devices. By way of example and not limitation, a memory device may include 2D or 3D structures of memory arrays. Thus, the managed memory device may include the memory controller and one or more memory devices. In an example, the managed memory device may be a discrete memory or storage device component of the host device. In other examples, the managed memory device may be a portion of an integrated circuit (e.g., system on a chip (SOC), etc.), stacked or otherwise included with one or more other components of the host device.

One or more communication interfaces can be used to transfer data between the managed memory device and one or more other components of the host device, such as a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. Data may be transferred between the managed memory device and other components over an I/O bus.

The memory controller 812 may receive instructions from processing circuitry (e.g., a processor) of the host device 801, and can communicate with the memory array 813, such as to transfer data to (e.g., write or erase) or from (e.g., read) one or more of the memory devices and associated memory cells, planes, sub-blocks, blocks, or pages of the memory array. The memory controller may include, among other things, circuitry or firmware, including one or more components or integrated circuits. For example, the memory controller may include one or more circuits, control circuitry, or components configured to control access across the memory array and to provide a translation layer between the host device and the memory devices of the memory array. The memory controller may include one or more input/output (I/O) circuits, lines, or interfaces to transfer data to or from the memory array. The memory controller 812 may include a memory manager 840 and an array controller 841. The array controller may include, among other things, circuitry or components configured to control memory operations associated with writing data to, reading data from, or erasing one or more memory cells of the memory devices in the memory array. The memory operations can be based on, for example, host commands received from processing circuitry of the host device, or internally generated by the memory manager (e.g., in association with wear leveling, error detection or correction, etc.). In operation, data is typically written to or read from a NAND managed memory device in pages and erased in blocks. However, one or more memory operations (e.g., read, write, erase, etc.) can be performed on larger or smaller groups of memory cells, as desired. The data transfer size of a NAND managed memory device is typically referred to as a page, whereas the data transfer size of a host is typically referred to as a sector.

Different types of memory devices can provide for different page sizes or can require different amounts of metadata associated therewith. For example, different memory device types can have different bit error rates, which can lead to different amounts of metadata necessary to ensure integrity of the page of data (e.g., a memory device with a higher bit error rate can require more bytes of error correction code data than a memory device with a lower bit error rate). As an example, a multi-level cell (MLC) NAND flash memory device can have a higher bit error rate than a corresponding single-level cell (SLC) NAND flash memory device. As such, the MLC device can require more metadata bytes for error data than the corresponding SLC device.

Examples, as described herein, can include, or can operate by, logic, components, devices, packages, or mechanisms. Circuitry is a collection (e.g., set) of circuits implemented in tangible entities that include hardware (e.g., simple circuits, gates, logic, etc.). Circuitry membership can be flexible over time and underlying hardware variability. Circuitries include members that can, alone or in combination, perform specific tasks when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

The above detailed description is intended to be illustrative, and not restrictive. The scope of the disclosure should, therefore, be determined with references to the appended claims, along with the full scope of equivalents to which such claims are entitled.

What is claimed is:

1. A memory device for connecting with a host in a system, the memory device comprising:
an array of memory cells; and
a memory controller configured for controlling access to the array of memory cells, the memory controller being configured to perform one or more memory device functions that enable the host to perform system operations,
wherein the memory controller includes:
at least one safety mechanism configured to determine at least one memory device fault condition that has a potential to adversely affect performance of at least one of the one or more memory device functions, and
at least one safety mechanism monitor configured to determine at least one safety mechanism fault condition that has a potential to adversely affect an ability of the at least one safety mechanism to determine the at least one memory device fault condition.

2. The memory device of claim 1, wherein the at least one safety mechanism monitor is configured to force a failure in performing at least one of the one or more memory device functions for the at least one safety mechanism and configured to determine the at least one safety mechanism fault condition based on whether the at least one safety mechanism detected the forced failure.

3. The memory device of claim 2, wherein the memory controller is configured to reset the at least one memory device fault condition in response a reset signal received from the host after the failure is forced.

4. The memory device of claim 1, wherein the at least one safety mechanism monitor determines the at least one safety mechanism fault condition intermittently.

5. The memory device of claim 4, wherein the at least one safety mechanism fault condition is determined during times when the system is neither booting up nor performing normal system operations that are enabled by the one or more memory device functions.

6. The memory device of claim 1, wherein the at least one safety mechanism monitor is configured to store the at least one safety mechanism fault condition in nonvolatile memory for access by the host to assess whether the at least one safety mechanism is reliable.

7. The memory device of claim 1, wherein the at least one safety mechanism is configured to react to the at least one memory device fault condition using a reaction path that includes at least one of firmware interrupts or a hardware path, and the at least one safety mechanism monitor is configured to use the reaction path to demonstrate coverage for the reaction path.

8. The memory device of claim 1, further comprising using an alert system and status flags for the at least one safety mechanism to react to the at least one memory device fault condition, and using the alert system and the status flags for the at least one safety mechanism monitor to demonstrate coverage.

9. A system, comprising:
a host configured to perform system operations within an automotive system configured to provide assisted driving functions or autonomous driving functions; and
a memory device including an array of memory cells and a memory controller configured for controlling access to the array of memory cells, the memory controller being configured to perform one or more memory device functions that enable the host to perform the system operations,
wherein the memory controller includes:
at least one safety mechanism configured to determine at least one memory device fault condition that has a potential to adversely affect performance of at least one of the one or more memory device functions, and
at least one safety mechanism monitor configured to determine at least one safety mechanism fault condition that has a potential to adversely affect an ability of the at least one safety mechanism to determine the at least one memory device fault condition, wherein the at least one safety mechanism monitor is configured to force a failure in performing at least one of the one or more memory device functions for the at least one safety mechanism and configured to determine the at least one safety mechanism fault condition based on whether the at least one safety mechanism detected the forced failure,
wherein the host is configured to assess whether the at least one safety mechanism is reliable based on the at least one safety mechanism fault condition and is further configured to assess whether the memory controller is reliable to perform the one or more memory device functions that enable the host to perform the system operations, and
wherein the memory controller is configured to reset the at least one memory device fault condition in response a reset signal received from the host.

10. The system of claim 9, wherein the at least one safety mechanism fault condition is intermittently determined during a key off event.

11. The system of claim 9, wherein the automotive system includes an Automotive Safety Integrity Level (ASIL) risk classification system, and the memory device includes Universal Flash Storage (UFS), Embedded Multi-Media Card (eMMC) storage, or a solid state drive (SSD).

12. A method performed using a host and a memory device that includes an array of memory cells and a memory controller configured for controlling access to the array of memory cells, wherein the method comprises:
performing one or more memory device functions, using the memory controller, that enable a host to perform system operations;
determining at least one memory device fault condition using at least one safety mechanism in the memory controller, wherein the at last one memory device fault condition has a potential to adversely affect performance of at least one of the one or more memory device functions; and
determining at least one safety mechanism fault condition using at least one safety mechanism monitor in the memory controller, wherein the at least one safety mechanism fault condition can adversely affect an ability of the at least one safety mechanism to determine the at least one memory device fault condition,
wherein the host is configured to assess whether the at least one safety mechanism is reliable based on the at least one safety mechanism fault condition and is configured to assess whether the memory controller is reliable to perform the one or more memory device functions that enable the host to perform the system operations.

13. The method of claim 12, further comprising:
forcing a failure, using the at least one safety mechanism monitor, in performing at least one of the one or more memory device functions;
using the at least one safety mechanism to determine the at least one memory device fault condition when the failure is forced; and
using the at least one safety mechanism monitor to determine the at least one safety mechanism fault condition based on whether the at least one safety mechanism detected the failure.

14. The method of claim 13, further comprising receiving a reset signal from the host after the failure is forced, and responding to the received reset signal by using the memory controller to reset the at least one memory device fault condition.

15. The method of claim 12, wherein the at least one safety mechanism fault condition is intermittently determined.

16. The method of claim 15, wherein the at least one safety mechanism fault condition is determined during times when the system is neither booting up nor performing normal system operations that are enabled by the one or more memory device functions.

17. The method of claim 12, further comprising storing the at least one safety mechanism fault condition in nonvolatile for access by the host to assess whether the at least one safety mechanism is reliable.

18. The method of claim 12, further comprising using a reaction path that includes at least one of firmware interrupts or a hardware path for the at least one safety mechanism to react to the at least one memory device fault condition, and using the reaction path for the at least one safety mechanism monitor to demonstrate coverage for the reaction path.

19. The method of claim 12, further comprising using an alert system and status flags for the at least one safety mechanism to react to the at least one memory device fault condition, and using the alert system and the status flags for the at least one safety mechanism monitor to demonstrate coverage.

20. The method of claim 12, wherein the system operations include operations for an automotive system, and the memory device includes Universal Flash Storage (UFS), Embedded Multi-Media Card (eMMC) storage, or a solid state drive (SSD).
